(19) United States
(12) Patent Application Publication
(10) Pub. No.: US 2026/0087911 A1
(43) Pub. Date: Mar. 26, 2026

(54) RETAIL TRANSACTION PROCESSING SYSTEM WITH DETECTION APPARATUS

(71) Applicant: Toshiba Tec Kabushiki Kaisha, Tokyo (JP)

(72) Inventor: Naotake HIRAMATSU, Ota Tokyo (JP)

(21) Appl. No.: 19/240,637

(22) Filed: Jun. 17, 2025

(30) Foreign Application Priority Data
Sep. 20, 2024 (JP) 2024-163778

(51) Int. Cl. G07G 3/00; G06Q 20/20

(52) U.S. Cl. CPC G07G 3/003; G06Q 20/202; G06Q 20/208; G06Q 20/209

(57) ABSTRACT

According to one embodiment, a retail transaction processing system includes a point-of-sale terminal and a detection apparatus. The detection apparatus receives images from a camera positioned to image operations at the point-of-sale terminal and a transaction start/end indication from the point-of-sale terminal when a user begins and ends a transaction checkout operation. Upon receiving the transaction start indication, the detection apparatus begins detecting items in the received image and creates a detected item list. Upon receiving the checkout operation end indication, the detection apparatus stops detecting items in the received images and receives a registered item list from the point-of-sale terminal. The detection apparatus then compares the detected item list to the registered item list and outputs a notification when an item on the detected item list has no corresponding item on the registered item list.

### CROSS-REFERENCE TO RELATED APPLICATION

This application is based upon and claims the benefit of priority from Japanese Patent Application No. 2024-163778, filed Sep. 20, 2024, the entire contents of which are incorporated herein by reference.

### FIELD

Embodiments described herein relate to an information processing system for retail transactions. The system includes a detection apparatus for identifying misregistration of products.

### BACKGROUND

A self-checkout system in which a customer performs commodity registration and makes a payment by himself/herself has become widespread due to shortage of manpower, increases in labor costs, and the like.

However, since a customer commodity performs registration and makes a payment by himself/herself in such a self-checkout system, erroneous or fraudulent commodity registration acts such as scan omission or other fraudulent acts often occurs. In particular, when a high-priced commodity is not properly scanned for checkout, the profits of the store may be greatly affected.

### BRIEF DESCRIPTION OF THE DRAWINGS

FIG. 1 is a block diagram schematically illustrating an information processing system according to an embodiment.

FIG. 2 is a diagram illustrating an imaging range of a camera.

FIG. 3 is a block diagram illustrating a POS terminal.

FIG. 4 is a table illustrating a configuration example of a commodity master.

FIG. 5 is a table illustrating a configuration example of registration information.

FIG. 6 is a block diagram illustrating a detection terminal.

FIG. 7 is a table illustrating a configuration example of specific commodity information.

FIG. 8 is a table illustrating a configuration example of detection information.

FIG. 9 is a block diagram illustrating an attendant terminal.

FIG. 10 is a diagram illustrating a commodity registration screen displayed on a display device of a POS terminal.

FIG. 11 is a diagram illustrating an alert screen displayed on the display device.

FIG. 12 is a sequence diagram illustrating a processing example of an information processing system of an embodiment.

### DETAILED DESCRIPTION

A technical solution for reducing inappropriate commodity registration performed by a customer in self-registration systems is provided.

In general, according to one embodiment, a retail transaction processing system includes a point-of-sale terminal and a detection apparatus communicatively connected to the point-of-sale terminal. The detection apparatus is configured to: receive images from a camera positioned to image operations at the point-of-sale terminal; receive a transaction start indication from the point-of-sale terminal when a user begins a transaction checkout operation at the point-of-sale terminal; upon receiving the transaction start indication, begin detecting items in the received images from the camera; create a detected item list for items detected in the received images; receive a checkout operation end indication from the point-of-sale terminal; upon receiving the checkout operation end indication, stop detecting items in the received images from the camera; receive a registered item list for items registered at the point-of-sale terminal in the transaction checkout operation at the point-of-sale terminal; compare the detected item list to the registered item list; and output a notification when an item on the detected item list has no corresponding item on the registered item list.

Hereinafter, certain example embodiments will be described with reference to the drawings. In the drawings, the depicted scale, dimension, and the like of each part may be appropriately changed. In the drawings, certain aspects or elements may be omitted for the sake of simplicity in description.

### Embodiment

### Configuration Example

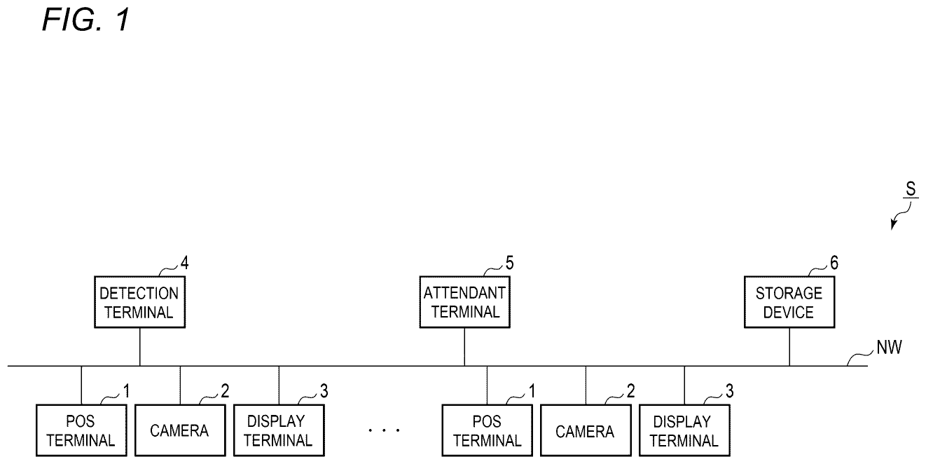

FIG. 1 is a block diagram illustrating an information processing system S.

The information processing system S is a system that connects a plurality of devices and processes information related to transactions in a store. For example, the store is a mass-scale shop such as a supermarket, but is not limited thereto. In this context, a transaction is a sale of commodities by the store accompanied by payment from the customer. From the viewpoint of the store, the transaction is a selling of goods. From the viewpoint of the customer, the transaction is a purchasing of goods. As used here, a “commodity” includes not only a physical article, but also a service, a ticket, or the like.

The information processing system S includes a plurality of point of sales (POS) terminals 1, a plurality of cameras 2, a plurality of display terminals 3, one detection terminal 4, one attendant terminal 5, and one storage device 6 installed in a store.

The devices provided in the information processing system S are communicably connected to each other via a network NW. The network NW is a local area network (LAN) or the like. The LAN may be a wireless LAN or a wired LAN. The devices may be communicably connected to each other via a universal serial bus (USB) instead of the network NW.

In a store, one POS terminal 1, one camera 2, and one display terminal 3 are installed together as one set or grouping. In other examples, one POS terminal 1, a plurality of cameras 2, and one display terminal 3 may be installed as one set or grouping.

The information processing system S may include just one POS terminal 1 instead of a plurality of POS terminals 1. In this case, the information processing system S may similarly include one camera 2 instead of a plurality of cameras 2 and one display terminal 3 instead of a plurality of display terminals 3. The information processing system S may include a plurality of detection terminals 4 instead of just one detection terminal 4. The information processing system S may include a plurality of attendant terminals 5 instead of just one attendant terminal 5. The information processing system S may include a plurality of storage devices 6 instead of just one storage device 6.

The POS terminal 1 is a device that processes transactions in a store. Here, it is assumed that the POS terminal 1 has a commodity registration function and a payment function and constitutes a self-checkout system with which a customer can perform an operation of commodity registration and an operation of making a payment. The POS terminal 1 is an example of a transaction processing apparatus. The transaction processing apparatus is an example of an information processing apparatus.

In this context, commodity registration is registration of a commodity for payment in a transaction. A commodity that has been registered is also referred to as a registered commodity. The payment is payment for completing the transaction after the commodity registration. The payment includes the meaning of settlement. Payment methods for payment in a transaction includes offline settlement and online settlement.

The offline settlement is payment that does not require the POS terminal 1 to cooperate with other devices via a network such as the Internet. For example, the offline settlement is payment using cash, a cash voucher, or the like. Examples of a cash voucher include, but are not limited to, various types of a commodity coupon, a gift voucher, a rice voucher, a beer voucher, a complimentary ticket for a stockholder, a regional promotion coupon, and a coupon. A cash voucher may be a physical cash voucher (e.g., a printed document) or a digitized cash voucher (e.g., an image displayed on a smartphone screen).

The online settlement is payment executed by the POS terminal 1 in cooperation with another device via a network such as the Internet. Examples of the online settlement include credit card settlement, electronic money settlement, debit card settlement, and code settlement.

In this example, a camera 2 has an imaging range covering one POS terminal 1. The imaging range associated with a specific POS terminal 1 covers a field of view within which each commodity brought to the POS terminal 1 by a customer for transaction can be seen (imaged). Therefore, the commodity included in the captured image is a commodity to be registered. The imaging range covers the vicinity (surroundings) of the specific POS terminal 1. For example, the range covers the area in which the customer performs operations at the POS terminal 1. For example, the camera 2 is an artificial intelligence (AI) camera. The camera 2 is an example of an imaging device that acquires a captured image.

The display terminal 3 displays an image for a customer. For example, the display terminal 3 incorporates a display device such as a liquid crystal display or an electroluminescence (EL) display. The display terminal 3 is an example of a display unit for a customer.

The detection terminal 4 is an apparatus that detects a commodity based on captured images acquired by one or more cameras 2. For example, the detection terminal 4 is an edge personal computer (PC). The detection terminal 4 is an example of an information processing apparatus that processes information about a transaction. Hereinafter, a commodity detected based on the captured image is also referred to as a detected commodity. Here, it is assumed that the detection terminal 4 is provided to detect specific commodities in the captured image(s).

The specific commodities are a set of commodities that have a large influence on the profit and loss of a store. For example, valuable items and/or frequently stolen items may be included in the set of specific commodities. That is, items which if taken away from the store without payment by inappropriate commodity registration such as scan omission or fraudulent act cause large store losses are included in the set. For example, the specific commodity is an expensive commodity.

The specific commodity may be set by a commodity category. A particular specific commodity included in the set is also referred to as a first-type specific commodity. A specific commodity included in the set by a commodity category is also referred to as a second-type specific commodity.

The first-type specific commodity is a commodity that can be identified by one commodity code. The commodity code is a code by which a particular commodity can be uniquely identified. For example, the commodity code is a Japanese Article Number (JAN) code. The commodity code is an example of commodity identification information with which a commodity can be uniquely identified.

The second-type specific commodity are commodities within a particular commodity category that includes a plurality of commodities identifiable by a plurality of commodity codes. For example, a commodity category is a category including a plurality of commodities having similar appearances, features, or the like. A commodity category can be, but is not limited to, melons, luxury Japanese-produced beef, six-can packs of sake, and large-sized commodities. A category may comprise both a six-can pack of sparkling wine and a six-can pack of beer. When the second-type specific commodity is “a melon” or “luxury beef,” the second-type specific commodity can include not only a product from YY geographic location but also a product XX geographic location. When the second-type specific commodity is a six-can pack of sake, the category may cover sake from different manufacturers.

The attendant terminal 5 is a device used by an attendant (e.g., a store clerk with monitoring responsibilities). The attendant terminal 5 may be a dedicated device or a device such as a smartphone, a tablet terminal, or a PC. The attendant terminal 5 is an example of an information processing apparatus that processes information for a transaction.

The storage device 6 stores information. For example, the storage device 6 is a network attached storage (NAS), device but is not limited thereto. The storage device 6 may be a device in a data center outside the store.

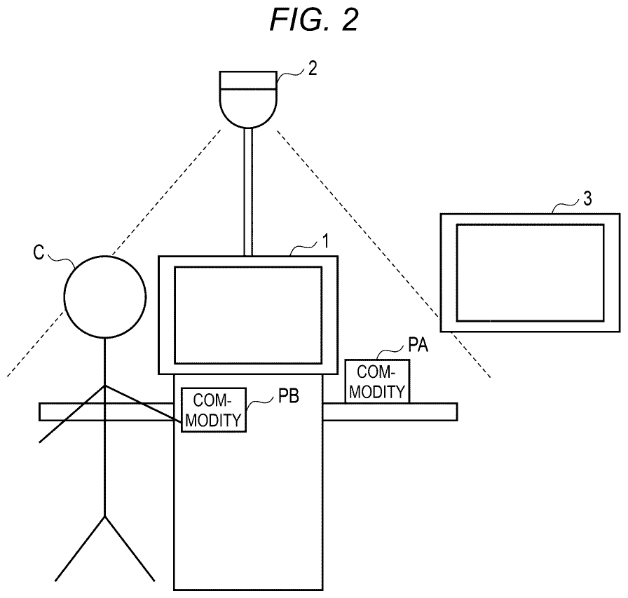

FIG. 2 is a diagram illustrating an imaging range of the camera 2 according to the embodiment.

The camera 2 is installed to capture an image of the vicinity of the POS terminal 1. The camera 2 captures an image of a commodity PA and a commodity PB brought to the POS terminal 1 by a customer C. Here, although one camera 2 is installed to capture an image of the vicinity of one POS terminal 1, multiple cameras 2 may be installed to capture an image of the vicinity of the POS terminal 1. The display terminal 3 is installed at a position easily visible to the customer C at the POS terminal 1.

It is assumed in this explanation that the commodity PA is a specific commodity (a listed or controlled item) and the commodity PB is not a specific commodity (not a listed or controlled item). In this case, the detection terminal 4 detects the commodity PA but does not perform processing specifically to detect the commodity PB in the captured images acquired by the one or more cameras 2.

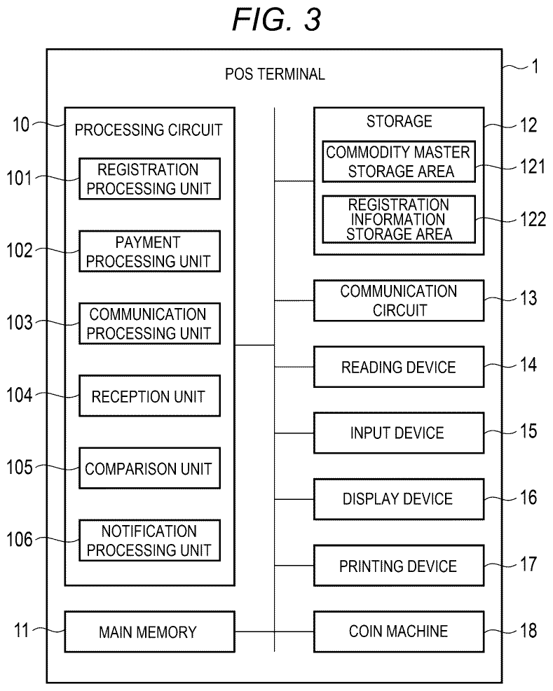

FIG. 3 is a block diagram illustrating the POS terminal 1.

The POS terminal 1 includes a processing circuit 10, a main memory 11, a storage 12, a communication circuit 13, a reading device 14, an input device 15, a display device 16, a printing device 17, and a coin machine 18. The processing circuit 10, the main memory 11, the storage 12, the communication circuit 13, the reading device 14, the input device 15, the display device 16, the printing device 17, and the coin machine 18 are connected to each other so as to be able to input and output signals.

The processing circuit 10 corresponds to a central processing unit of the POS terminal 1. The processing circuit 10 includes one or more circuits that execute a plurality of types of processing by a plurality of functions. For example, the processing circuit 10 is a processor, an application specific integrated circuit (ASIC), or a field-programmable gate array (FPGA), but is not limited thereto. For example, the processor is a central processing unit (CPU) or a graphics processing unit (GPU), but is not limited thereto. The processing circuit 10 executes a program stored in the main memory 11 or the storage 12. The processing circuit 10 executes the program to enable execution of various types of processing.

The main memory 11 includes a nonvolatile memory area and a volatile memory area. The main memory 11 stores an operating system or a program in the nonvolatile memory area. The main memory 11 uses the volatile memory area as a work area in which data is appropriately rewritten by the processing circuit 10. For example, the main memory 11 includes a read only memory (ROM) as the nonvolatile memory area. For example, the main memory 11 includes a random access memory (RAM) as the volatile memory area. The main memory 11 is an example of a storage unit of the POS terminal 1.

The storage 12 corresponds to an auxiliary storage part of the POS terminal 1. The storage 12 includes one or more storage devices. For example, the storage device may be a hard disk drive (HDD) or a semiconductor storage medium such as a solid state drive (SSD), but is not limited thereto. The storage 12 stores the above-described program, data used by the processing circuit 10 to execute various types of processing, and data generated by the processing of the processing circuit 10. The storage 12 is an example of the storage unit of the POS terminal 1.

The storage 12 may include a commodity master storage area 121. The commodity master storage area 121 stores a commodity master. The commodity master includes information about each commodity sold in the store. The information about a commodity may include identification information, a commodity name, and a price.

The identification information may include a commodity code on the commodity. The identification information o may include category identification information about a commodity category to which the commodity belongs. The category identification information is identification information by which a commodity category can be uniquely identified. For example, the category identification information may be a category code. The category identification information may be a flag value by which items can be identified as being a specific (listed) commodity or not. The commodity name can be a plain language name of the commodity. The price is the unit price of the commodity. The unit price is the amount of money due per each instance (unit) of the commodity. The stored information about a commodity may include information other than the above information.

The storage 12 may include a registration information storage area 122. The registration information storage area 122 stores registration information. The registration information is information based on commodity registration in a transaction. The registration information includes information from a commodity master for registered items. The registration information includes information for each registered commodity. The information about a registered commodity may include information such as identification information, a commodity name, a price, a quantity, and a commodity amount.

The identification information about a registered commodity may include a commodity code for the registered commodity. The identification information may include category identification for a commodity category to which the registered commodity belongs. The commodity name is a name of the registered commodity. The price is a unit price of the registered commodity. The commodity amount is the amount of money due based on the unit price multiplied by the quantity. The information about a registered commodity may include information other than the above information. The registration information storage area 122 may be provided in the main memory 11 instead of the storage 12.

The communication circuit 13 is a circuit including various interfaces for transmitting or receiving signals. The communication circuit 13 communicably connects the POS terminal 1 to other devices via the network NW.

The reading device 14 is a device that reads various code symbols. The reading device 14 may be a scanner that performs reading by sensing or a camera that performs reading by imaging. For example, the code symbol is a barcode symbol or a two-dimensional code symbol. The code symbol may be a code symbol of a commodity in which commodity identification information is recorded. The code symbol of a commodity is an image attached to the commodity. The code symbol may be a code symbol in which member identification information enabling unique identification of a customer as a member of a store is recorded. The code symbol in which the member identification information is recorded may be an image attached to a membership card or an image that can be displayed on a terminal. The code symbol may be a code symbol for code settlement. The code symbol may be a code symbol in which attendant identification information enabling unique identification of an attendant is recorded. The code symbol in which the attendant identification information is recorded may be an image attached to a card or an image that can be displayed on a terminal. The reading device 14 is an example of a reading unit of the POS terminal 1.

The input device 15 is a device capable of inputting an instruction or information to the POS terminal 1. The input device 15 may include a keyboard. The input device 15 may constitute a touch screen together with the display device 16. The input device 15 is an example of an input unit of the POS terminal 1.

The display device 16 is a device capable of displaying various images under control of the processing circuit 10. For example, the display device 16 is a liquid crystal display or an EL display. The display device 16 is an example of a display unit of the POS terminal 1. The display unit of the POS terminal 1 is an example of a display unit for the customer.

The printing device 17 is a printer or the like for issuing a printed matter by printing on a medium. For example, the medium is paper. For example, the printing device 17 is a thermal printer or an inkjet printer, and is not limited thereto. The printing device 17 is an example of a printing unit of the POS terminal 1.

The coin machine 18 is a device capable of receiving and discharging cash used in payment for a transaction.

The hardware configuration of the POS terminal 1 is not limited to the above-described configuration. In the POS terminal 1, the above-described components may be appropriately omitted or changed, and other components may be added.

Each unit implemented by the processing circuit 10 will be described.

The processing circuit 10 implements a registration processing unit 101, a payment processing unit 102, a communication processing unit 103, a reception unit 104, a comparison unit 105, and a notification processing unit 106.

The registration processing unit 101 processes commodity registrations in a transaction. For example, processing for commodity registration is to update the registration information. Updating the registration information includes adding information about a registered commodity, increasing a quantity included in the information about the registered commodity, reducing the quantity included in the information about the registered commodity, and deleting the information about the registered commodity.

The payment processing unit 102 processes payments in a transaction to settle a payment amount (transaction amount due). The payment amount is the amount of money required to conclude the transaction. For example, the payment amount is a total amount for the transaction at the end of the commodity registration. The total amount for the transaction is the amount of money obtained based on a total of individual prices of the registered commodities. Processing the payment includes finalizing the payment.

The communication processing unit 103 processes reception and transmission of signals via the communication circuit 13.

The reception unit 104 receives an instruction or information that is input to the POS terminal 1 by the customer using the input device 15.

The comparison unit 105 compares all registered commodities and all detected commodities in a transaction based on an instruction input by the customer. The comparison information is information about a comparison result based on comparison between the registered commodities in the transaction and the detected commodities in the transaction. The comparison result indicates a first case or a second case. The first case is that at least one detected commodity is not included among the registered commodities in the transaction. The second case is that all the detected commodities are included in the registered commodities in the transaction.

An instruction input by the customer can be a registration end instruction or a payment instruction. The registration end instruction is an instruction for ending the commodity registration process. The registration end instruction can be an instruction for ending the commodity registration process or starting an operation for payment. The payment instruction is an instruction related to the payment process or the like after the commodity registration. The payment instruction may be an instruction for selecting a payment method. The payment instruction may be an instruction for settling the payment amount by a selected payment method. The payment instruction may be an instruction other than these specific instructions. When the POS terminal 1 is of a type requiring a registration end instruction, the payment instruction is an instruction input after the registration end instruction. When the POS terminal 1 is of a type not requiring a registration end instruction, the payment instruction can be input directly after commodity registration.

The notification processing unit 106 executes processing for outputting a notification based on comparison information. The output of a notification can be a display of a notification or voice (sound) output of the notification.

The notification is an alert regarding an unregistered commodity. An unregistered commodity is a commodity that has not been registered when the registration end instruction (or the payment instruction) is input. For example, the unregistered commodity is a detected commodity not included (listed) among the registered commodities in the transaction. The notification may include information about the presence of an unregistered commodity. The information about the presence of an unregistered commodity is information enabling recognition of the presence of the unregistered commodity. The information enabling recognition of the presence of an unregistered commodity may be information indicating the presence of an unregistered commodity or information indicating confirmation of whether there is no unregistered commodity. The information about the presence of an unregistered commodity may be a character string, an image, or other types of information. The notification may include information indicating an unregistered commodity. The information indicating an unregistered commodity is information enabling recognition of the unregistered commodity. The information enabling recognition of an unregistered commodity may be information indicating a commodity name of the unregistered commodity. The information indicating an unregistered commodity may be a character string, an image, or other types of information.

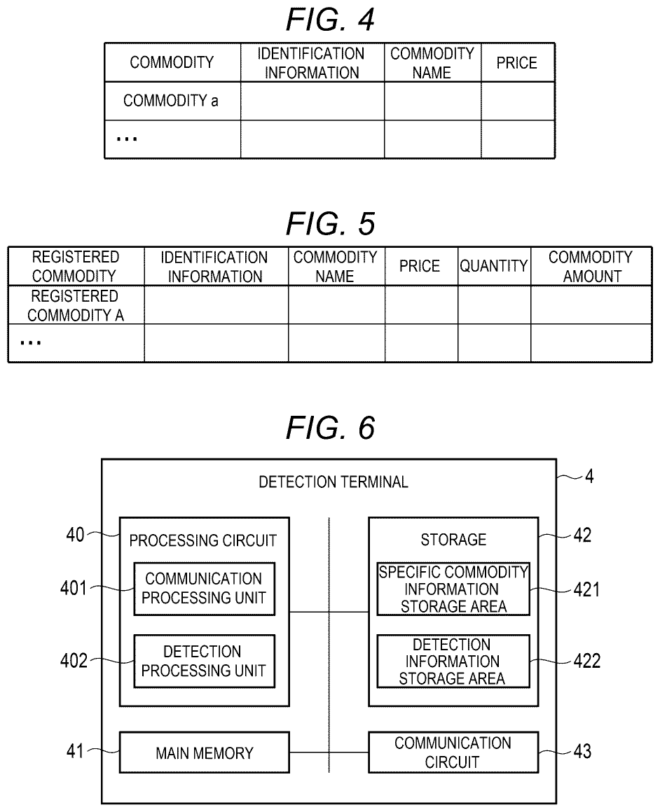

FIG. 4 is a table illustrating a configuration example of a commodity master stored in the commodity master storage area 121.

The commodity master includes information about a commodity for each commodity sold in the store. As described above, the information about a commodity may include information about all or some of the identification information, the commodity name, and the price.

FIG. 5 is a table illustrating a configuration example of registration information stored in the registration information storage area 122.

The registration information includes information about a registered commodity for each registered commodity. As described above, the information about a registered commodity may include all or some of the identification information, the commodity name, the price, the quantity, and the commodity amount.

FIG. 6 is a block diagram illustrating the detection terminal 4.

The detection terminal 4 includes a processing circuit 40, a main memory 41, a storage 42, and a communication circuit 43. The processing circuit 40, the main memory 41, the storage 42, and the communication circuit 43 are connected to each other so as to be able to input and output signals.

The processing circuit 40 corresponds to a central processing unit of the detection terminal 4. The processing circuit 40 includes one or more circuits that execute a plurality of types of processing by a plurality of functions. The processing circuit 40 loads a program stored in the main memory 41 or the storage 42 into the main memory 41. The processing circuit 40 executes the program loaded into the main memory 41 to enable execution of various types of processing.

The main memory 41 may be implemented in a manner similar to the main memory 11. The main memory 41 is an example of a storage unit of the detection terminal 4.

The storage 42 corresponds to an auxiliary storage part of the detection terminal 4. The storage 42 includes one or more storage devices. The storage 42 stores the above-described program, data used by the processing circuit 40 to execute various types of processing, and data generated by the processing of the processing circuit 40. The storage 42 is an example of the storage unit of the detection terminal 4.

The storage 42 may include a specific commodity information storage area 421. The specific commodity information storage area 421 stores specific commodity information. The specific commodity information includes information about each specific (listed/controlled) commodity, such as a commodity name, image information, and identification information.

When the commodity is a first-type specific (listed) commodity, the commodity is just the name of the first-type specific commodity. When the commodity is a second-type specific (listed) commodity, the commodity name is a name of a commodity category including the second-type specific commodity.

The image information about a specific (listed) commodity is an image used for detecting or identifying the commodity. The image used for detecting a specific commodity is a reference image indicating features of the commodity so designated as a specific (listed) commodity.

The storage 42 may include a detection information storage area 422. The detection information storage area 422 stores detection information. The detection information is information based on captured images acquired by one or more cameras 2. The detection information is information varies based on the specific commodity information. The detection information includes information about a detected commodity for each detection ID. The detection ID is an ID assigned to each detected commodity. Different detection IDs are assigned to different detected commodities.

When the detected commodity is a first-type specific commodity, the commodity name is just the name of the detected commodity. When the detected commodity is a second-type specific commodity, the commodity name is a name of a commodity category including the detected commodity (or at least the commodity category causing the detected commodity to be considered a second-type specific commodity).

The identification information about the detected commodity is the identification information of the specific commodity corresponding to the detected commodity. The detection information storage area 422 may be included in the main memory 41 instead of the storage 42.

The communication circuit 43 includes various interfaces for transmitting or receiving signals. The communication circuit 43 communicably connects the detection terminal 4 to other devices via the network NW.

The hardware configuration of the detection terminal 4 is not limited to the above-described configuration. In the detection terminal 4, the above-described components may be appropriately omitted or changed, and other components may be added.

Each unit implemented by the processing circuit 40 will be described.

The processing circuit 40 implements a communication processing unit 401 and a detection processing unit 402.

The communication processing unit 401 processes reception and transmission of signals via the communication circuit 43.

The detection processing unit 402 detects a commodity based on captured images acquired by one or more cameras 2.

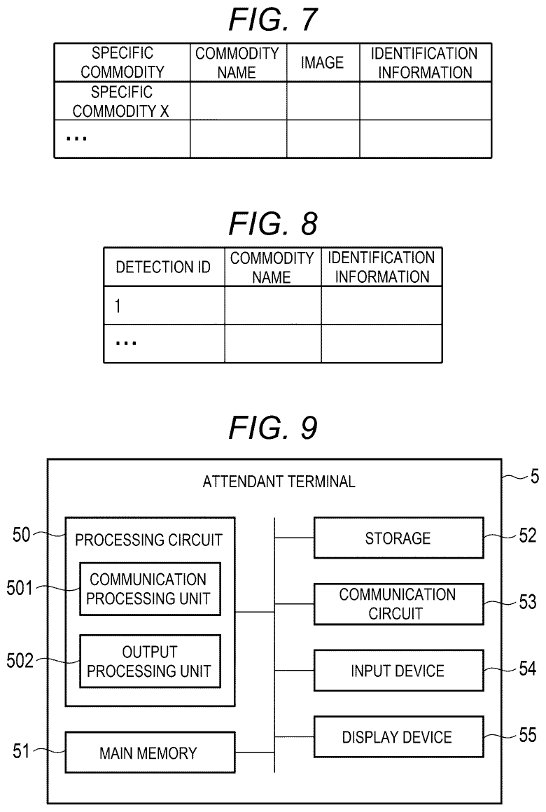

FIG. 7 is a table illustrating a configuration example of specific commodity information stored in the specific commodity information storage area 421.

The specific commodity information includes information about each specific commodity. As described above, the information about a specific commodity may include its commodity name, image information, and identification information.

FIG. 8 is a table illustrating a configuration example of detection information stored the detection information storage area 422.

The detection information includes information about a detected commodity for each detection ID. As described above, the information about a detected commodity may include the commodity name and the identification information.

FIG. 9 is a block diagram illustrating the attendant terminal 5.

The attendant terminal 5 includes a processing circuit 50, a main memory 51, a storage 52, a communication circuit 53, an input device 54, and a display device 55. The processing circuit 50, the main memory 51, the storage 52, the communication circuit 53, the input device 54, and the display device 55 are connected to each other so as to be able to input and output signals.

The processing circuit 50 corresponds to a central processing unit of the attendant terminal 5. The processing circuit 50 includes one or more circuits that execute a plurality of types of processing by a plurality of functions. The processing circuit 50 loads a program stored in the main memory 51 or the storage 52 into the main memory 51. The processing circuit 50 executes the program loaded into the main memory 51 to enable execution of various types of processing.

The main memory 51 may be implemented in a manner similar to the main memory 11. The main memory 51 is an example of a storage unit of the attendant terminal 5.

The storage 52 corresponds to an auxiliary storage part of the attendant terminal 5. The storage 52 includes one or more storage devices. The storage 52 stores the above-described program, data used by the processing circuit 50 to execute various types of processing, and data generated by the processing of the processing circuit 50. The storage 52 is an example of the storage unit of the attendant terminal 5.

The communication circuit 53 is a circuit providing various interfaces for transmitting or receiving signals. The communication circuit 53 communicably connects attendant terminal 5 to other devices via the network NW.

The input device 54 is a device capable of inputting an instruction or information into the attendant terminal 5. The input device 54 may include a keyboard. The input device 54 may constitute a touch screen integrated with the display device 55. The input device 54 is an example of an input unit of the attendant terminal 5.

The display device 55 is capable of displaying various images under control of the processing circuit 50. For example, the display device 55 is a liquid crystal display or an EL display. The display device 55 is an example of a display unit of the attendant terminal 5. The display unit of the attendant terminal 5 is an example of a display unit for an attendant.

The hardware configuration of the attendant terminal 5 is not limited to the above-described configuration. In the attendant terminal 5, the above-described components may be appropriately omitted or changed, and other components may be added.

Each unit implemented by the processing circuit 50 will be described.

The processing circuit 50 implements a communication processing unit 501 and an output processing unit 502.

The communication processing unit 501 processes reception and transmission of signals via the communication circuit 53.

The output processing unit 502 executes processing for outputting information. The output of information is described as display of information, and may be voice output of information.

### Display Examples

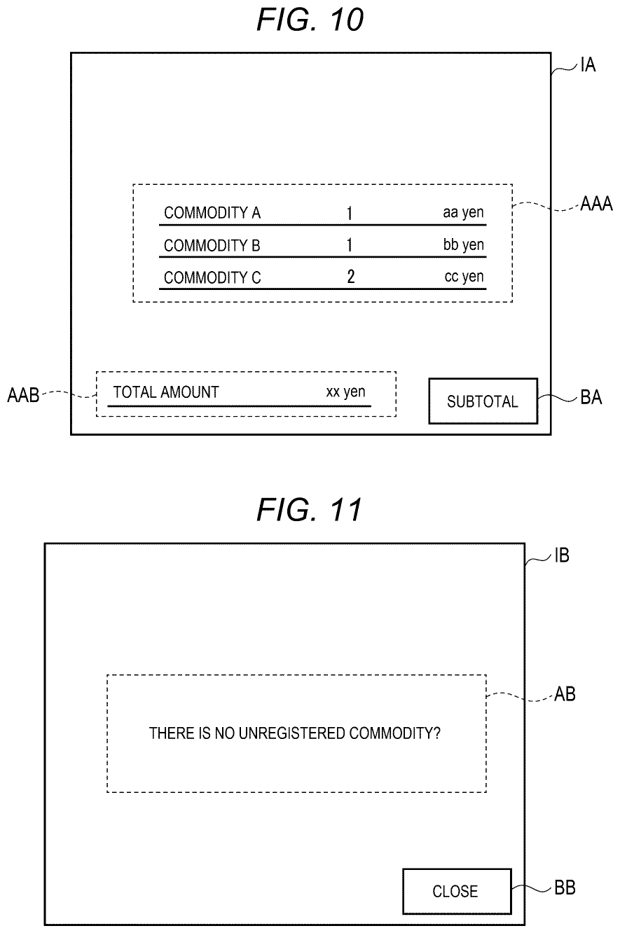

FIG. 10 is a diagram illustrating a commodity registration screen IA displayed on the display device 16 of the POS terminal 1.

The commodity registration screen IA is an image displaying information based on commodity registration.

The commodity registration screen IA includes a registered commodity display area AAA. The registered commodity display area AAA is an area for displaying a commodity name, a quantity, and a commodity amount for each registered commodity. The commodity registration screen IA includes a total amount display area AAB. The total amount display area AAB is an area for displaying the total amount of a transaction.

The commodity registration screen IA displays a “subtotal” button BA that can be selected using the input device 15. The “subtotal” button BA is a button for inputting a registration end instruction.

FIG. 11 is a diagram illustrating an alert screen IB displayed on the display device 16 of the POS terminal 1.

The alert screen IB is an image displaying a notification. The alert screen IB may be a pop-up.

The alert screen IB includes a notification display area AB. The notification display area AB is an area for displaying a notification. The notification includes a character string of “There is no unregistered commodity?” as information about the presence of an unregistered commodity. The notification may include information indicating an unregistered commodity instead of or together with the information about the presence of an unregistered commodity.

The alert screen IB displays a “close” button BB that can be selected using the input device 15. The “close” button BB is a button with which an instruction for canceling the alert screen IB can be input.

The alert screen IB may not display the “close” button BB. In this case, the alert screen IB cannot be cancelled by an operation of the customer, and can be cancelled based on an operation by of the attendant.

### Processing Example

A procedure of processing by the information processing system S will be described.

The processing procedure to be described below is merely an example, and processes may be changed or varied so long as substantially similar effects can be achieved. Specific acts in the described processing procedure below may be omitted, replaced, or combined in some examples. Likewise, additional acts or processing can be added thereto as appropriate according to the embodiment.

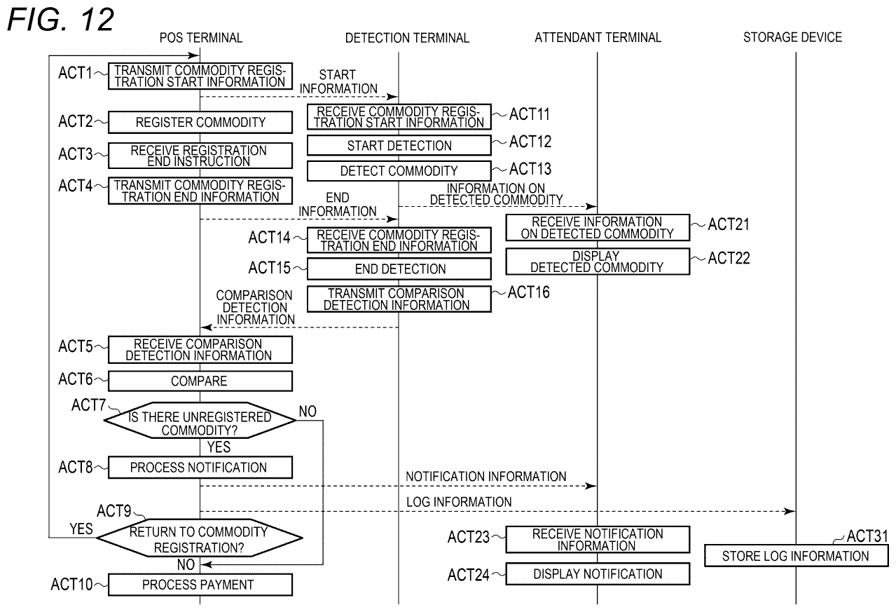

FIG. 12 is a sequence diagram illustrating a processing example of the information processing system S.

Here, it is assumed that a customer operates the POS terminal 1 for a transaction.

The processing circuit 10 of the POS terminal 1 transmits a commodity registration start for a transaction (ACT 1). ACT 1 may be processing executed by the communication processing unit 103. The commodity registration start is information indicating the start of commodity registration by the customer at the POS terminal 1. In ACT 1, for example, the processing circuit 10 detects the start of the commodity registration based on an instruction or information input by an operation performed by the customer. The processing circuit 10 may detect the start of the commodity registration based on a commodity registration start instruction input by the customer using the input device 15. The processing circuit 10 may detect the start of the commodity registration based on commodity identification information being input by the customer using the reading device 14. The processing circuit 10 may detect the start of the commodity registration based on member identification information being input by the customer using the reading device 14. The processing circuit 10 transmits commodity registration start information to the detection terminal 4 via the network NW upon the detection of the start of the commodity registration.

In this context, the transmitted commodity registration start information is an example of a trigger for starting the detections of the detection terminal 4 when the customer begins commodity registration. The trigger for starting the detection may be a signal transmitted from the POS terminal 1 to the detection terminal 4 once the customer starts the commodity registration process.

The processing circuit 40 of the detection terminal 4 receives the commodity registration start information (ACT 11). ACT 11 may be processing executed by the communication processing unit 401. The processing circuit 10 receives the commodity registration start information from the POS terminal 1 via the network NW.

The processing circuit 40 starts detection based on captured images acquired by one or more cameras 2 (ACT 12). ACT 12 may be processing executed by the detection processing unit 402. In ACT 12, for example, the processing circuit 40 starts the detection of a commodity based on the commodity registration start information.

The processing circuit 40 of the detection terminal 4 detects a commodity based on the captured images acquired by the one or more cameras 2 (ACT 12). ACT 12 may be processing executed by the detection processing unit 402. In ACT 12, for example, the processing circuit 40 refers to image information for each specific commodity included in specific commodity information, and detects when a commodity in a captured image is one of the specific commodities. The processing circuit 40 may detect a commodity before it has been registered or after. The processing circuit 10 assigns a detection ID to the detected commodity. The processing circuit 10 refers to the specific commodity information and stores information about the detected commodity in the detection information storage area 422 in association with the detection ID.

In this example, the processing circuit 40 detects a specific commodity in a captured image. That is, the detected commodity is the specific commodity. The processing circuit 40 does not need to specifically identify all the commodities included in the captured image, and thus the overall processing load can be reduced.

The processing circuit 40 can transmit information about a detected commodity to the attendant terminal 5 via the network NW each time a commodity is detected. The processing may be executed by the communication processing unit 401. Accordingly, each time a specific commodity is detected, the detection terminal 4 can notify that a specific commodity has been detected.

The processing circuit 50 of the attendant terminal 5 receives the information about the detected commodity (ACT 21). ACT 21 may be processing executed by the communication processing unit 501. In ACT 21, for example, the processing circuit 50 receives the information about the detected commodity from the detection terminal 4 via the network NW.

The processing circuit 50 of the attendant terminal 5 executes processing for displaying the detected commodity in conjunction with the information about the detected commodity (ACT 22). ACT 22 may be processing executed by the output processing unit 502. In ACT 22, for example, the processing circuit 50 causes the display device 55 to display a name of the specific commodity corresponding to the detected commodity based on a commodity name included in the information about the detected commodity. Accordingly, each time a specific commodity is detected, the attendant terminal 5 can notify that a specific commodity has been detected.

The processing circuit 10 of the POS terminal 1 includes the commodity registration in the transaction (ACT 2). ACT 2 may be processing executed by the registration processing unit 101. In ACT 2, for example, the processing circuit 10 acquires the commodity identification information of the commodity based on the commodity identification information input using the reading device 14. In some examples, processing circuit 10 may acquire the commodity identification information based on a commodity selection instruction input using the input device 15. The processing circuit 10 can refer to the commodity master stored in the commodity master storage area 121 and process the commodity registration based on the acquired commodity identification information.

The processing circuit 10 of the POS terminal 1 ultimately receives a registration end instruction from the customer input by using the input device 15 (ACT 3). ACT 3 may be processing executed by the reception unit 104. In ACT 3, for example, the processing circuit 10 receives the registration end instruction by the selection of the “subtotal” button BA by the customer.

The processing circuit 10 of the POS terminal 1 then transmits commodity registration end information (ACT 4). ACT 4 may be processing executed by the communication processing unit 103. The commodity registration end information signals the end of the commodity registration process by the customer. In ACT 4, for example, the processing circuit 10 detects the end of the commodity registration based on a registration end instruction being input by the customer using the input device 15. The processing circuit 10 transmits the commodity registration end information to the detection terminal 4 via the network NW based on the detection of the end of the commodity registration.

The commodity registration end information is an example of a trigger for ending the detection by the detection terminal 4 after the customer ends the commodity registration. The trigger for ending the detection may be a signal transmitted from the POS terminal 1 to the detection terminal 4 when the customer ends the commodity registration.

The processing circuit 40 of the detection terminal 4 receives the commodity registration end information (ACT 14). ACT 14 may be processing executed by the communication processing unit 401. The processing circuit 40 receives the commodity registration end information from the POS terminal 1 via the network NW.

The processing circuit 40 of the detection terminal 4 ends the detection of commodities in images acquired by the one or more cameras 2 (ACT 15). ACT 15 may be processing executed by the detection processing unit 402. In ACT 15, for example, the processing circuit 40 ends detection based on the commodity registration end information.

As described above, the processing circuit 40 detects commodities in a plurality of captured images constituting a moving image (e.g., video) acquired by one or more cameras 2 in the period between the receiving of the start information and the end information. Therefore, all the detected commodities for the transaction are commodities detected during the registration process. Accordingly, the detection terminal 4 can operate to continuously detect commodities only during a certain period of time, so that commodity detection accuracy may be improved.

In ACT 16, processing circuit 40 of the detection terminal 4 transmits comparison detection information to the POS terminal 1. ACT 16 may be processing executed by the communication processing unit 401. The comparison detection information comprises the detection information of all the detected commodities in the transaction. The comparison detection information includes the information about all the detected commodities in the transaction. In ACT 16, the processing circuit 40 transmits the comparison detection information to the POS terminal 1 via the network NW.

The processing circuit 10 of the POS terminal 1 receives the comparison detection information (ACT 5). ACT 5 may be processing executed by the communication processing unit 103. In ACT 5, for example, the processing circuit 10 receives the comparison detection information from the detection terminal 4 via the network NW.

The processing circuit 10 of the POS terminal 1 acquires comparison information after the registration end instruction (ACT 6). ACT 6 may be processing executed by the comparison unit 105. In ACT 6, for example, the processing circuit 10 acquires comparison registration information from the registration information storage area 122. The comparison registration information is registration information for all the registered commodities in the transaction. The comparison registration information includes the information about all the registered commodities in the transaction. The processing circuit 10 compares the comparison registration information to the comparison detection information. Here, the processing circuit 10 compares the identification information of each registered commodity included in the comparison registration information with the identification information of each detected commodity included in the comparison detection information. The processing circuit 10 can compare the registered commodities to the detected commodities by comparing the comparison registration information to the comparison detection information. The processing circuit 10 acquires comparison information based on a comparison between the registered commodities and the detected commodities.

The processing circuit 10 of the POS terminal 1 determines whether there is an unregistered commodity by using the comparison information (ACT 7). ACT 7 may be processing executed by the comparison unit 105. In ACT 7, for example, when a comparison result indicates that there is an unregistered commodity (ACT 7; YES), the processing proceeds to ACT 8. In ACT 7, when the identification information of at least one detected commodity is not included in the comparison registration information, it is considered that there is an unregistered commodity. When all the detected commodities are included in the comparison registration information, it is considered that there is no unregistered commodity (ACT 7; NO) and processing proceeds to ACT 10.

Examples of determining whether there is an unregistered commodity will be described.

In a first example, it is assumed that one detected commodity corresponds to a second-type specific commodity with a category of “melon”. The information about the detected commodity includes category identification information for a commodity category “melon”.

It is assumed that the transaction includes at least one registered commodity belonging to the commodity category “melon”. The comparison registration information also includes information about a registered commodity belonging to the commodity category “melon”. Therefore, a detected commodity corresponding to the second-type specific commodity “melon” is included among the registered commodities in the transaction. Therefore, the processing circuit 10 determines that there is no unregistered commodity related to the “melon” category.

If none of the registered commodities in the transaction is in commodity category “melon”, then category identification information for the commodity category “melon” is not included in the comparison detection information. Therefore, a detected commodity corresponding to the second-type specific commodity “melon” is not presently included among the registered commodities in the transaction. Therefore, the processing circuit 10 determines that there is an unregistered commodity corresponding to a “melon”.

In a second example, it is assumed that among detected commodities in the transaction are two commodities corresponding to the second-type specific commodity “melon”. When the comparison detection information includes information for each of the two detected commodities corresponding to a “melon” the is no problem when the transaction includes two registered commodities belonging to the commodity category “melon” since the two detected commodities corresponding to the category “melon” are included among the registered commodities in the transaction. Therefore, the processing circuit 10 determines that there is no unregistered commodity in this transaction.

if among the registered commodities in the transaction there is only one registered commodity belonging to the commodity category “melon”, the comparison registration information includes category identification for just the one registered commodity belonging to the commodity category “melon”. In this case, one of the two detected commodities corresponding to “melon” is not included among the registered commodities in the transaction. Therefore, the processing circuit 10 determines that there is an unregistered commodity corresponding to a “melon”.

When there is an unregistered commodity (ACT 7, YES), the processing transitions from ACT 7 to ACT 8. If there is no unregistered commodity (ACT 7, NO), the processing transitions from ACT 7 to ACT 10.

The processing circuit 10 of the POS terminal 1 executes processing for displaying a notification based on the comparison information (ACT 8). ACT 8 may be processing executed by the notification processing unit 106. In ACT 8, for example, when the comparison result indicates a possible unregistered item, the processing circuit 10 executes processing for displaying a notification.

The processing circuit 10 can execute processing for displaying the notification on the display device 16. In this example, the processing circuit 10 causes the display device 16 to display the notification like the alert screen IB (e.g., FIG. 11). Accordingly, the POS terminal 1 can draw the attention of the customer to the presence (and detection) of an unregistered commodity. By drawing attention, the POS terminal 1 can help prevent the unregistered commodity from being taken away from the store without payment.

The processing circuit 10 may execute the processing for displaying the notification on a display device of the display terminal 3 instead of displaying the notification on the display device 16. In this example, the processing circuit 10 transmits, to the display terminal 3, notification information for displaying the notification on the display device of the display terminal 3. The notification information may include a notification display instruction. The notification information may include information indicating contents of the notification. Accordingly, the POS terminal 1 can draw the attention to the unregistered commodity. The display terminal 3 displays the notification on the display device based on the notification information.

The processing circuit 10 can also execute processing for displaying a notification on the display device 55 of the attendant terminal 5. In this example, the processing circuit 10 transmits, to the attendant terminal 5 via the network NW, notification information for displaying a notification on the display device 55 of the attendant terminal 5. Accordingly, the POS terminal 1 can notify the attendant in real time that there is an unregistered commodity. The attendant can take an action for preventing the unregistered commodity from being taken away from the store without payment.

The processing circuit 50 of the attendant terminal 5 receives the notification information (ACT 23). ACT 23 may be processing executed by the communication processing unit 501. In ACT 23, the processing circuit 50 receives the notification information from the POS terminal 1 via the network NW.

The processing circuit 50 of the attendant terminal 5 executes the processing for displaying the notification based on the notification information (ACT 24). ACT 24 may be processing executed by the output processing unit 502. In ACT 24, the processing circuit 50 causes the display device 55 to display the notification based on the notification information.

The processing circuit 10 of the POS terminal 1 can transmit log information to the storage device 6 via the network NW. The log information may include the comparison registration information. The log information may include the comparison detection information. The storage device 6 stores the log information (ACT 31). Accordingly, an attendant can check the status of the commodity registration performed by a customer by checking the log information later.

After executing the processing for displaying the notification, the processing circuit 10 of the POS terminal 1 determines whether to return to the commodity registration (ACT 9). In ACT 9, the processing circuit 10 may determine to return to the commodity registration based on an instruction for returning to the commodity registration input by the customer using the input device 15. When returning to the commodity registration (ACT 9, YES), the processing transitions from ACT 9 to ACT 1. When not returning to the commodity registration (ACT 9, NO), the processing transitions from ACT 9 to ACT 10.

The processing circuit 10 of the POS terminal 1 processes payment for the transaction (ACT 10). ACT 10 may be processing executed by the payment processing unit 102.

In ACT 8, the processing circuit 10 of the POS terminal 1 may determine, based on a number of unregistered commodities that have been detected, whether to execute the processing for displaying the notification on the display device 16. In this present example, when the number of unregistered commodities is less than a threshold number, the processing circuit 10 does not execute the processing for displaying the notification on the display device 16. When the number of unregistered commodities is equal to or greater than the threshold, the processing circuit 10 executes the processing for displaying the notification on the display device 16. The threshold number can be appropriately set according to store preference. Similarly, the processing circuit 10 may determine, based on the number of unregistered commodities, whether to execute the processing for displaying the notification on the display device of the display terminal 3. Accordingly, the POS terminal 1 can control the necessity of displaying the notification in consideration of the risk of erroneous detection of an unregistered commodity.

In ACT 6, the processing circuit 10 of the POS terminal 1 may acquire the comparison information based on receipt of a payment instruction instead of the registration end instruction. As such, in ACT 3, the processing circuit 10 receives a payment instruction input by the customer using the input device 15. In ACT 4, the processing circuit 10 transmits the commodity registration end information to the detection terminal 4 based on the detection of the payment instruction input by the customer using the input device 15. Here, since the payment instruction is an instruction input after the commodity registration is notionally completed, it can be assumed that the commodity registration by the customer has ended by the time when the payment instruction is input. In ACT 15, the timing at which the processing circuit 40 ends the detection of the commodity based on the commodity registration end information can be based on receiving the payment instruction.

In this case, after the payment instruction is input, the processing circuit 10 of the POS terminal 1 executes the processing for displaying the notification as appropriate. Therefore, the notification may be displayed on the display device 16 and/or the display device of the display terminal 3 after the payment processing performed by the processing circuit 10 begins. In this case, after confirming the notification, the customer can voluntarily begin the commodity registration for the unregistered commodity as a new transaction. In some examples, the attendant may start commodity registration of the unregistered commodity for the customer as a new transaction instead of the customer doing so.

In an above-described example, the processing circuit 10 starts the comparison between the registered items and the detected items based on the registration end instruction or the payment instruction, and acquires the comparison information based on a comparison between registered and detected items, but the embodiment is not limited thereto. The processing circuit 10 may start the performing a comparison between the registered items and the detected items before the registration end instruction or the payment instruction is received and acquire a finalized comparison result based on receiving the registration end instruction or the payment instruction. In such an example, the processing circuit 10 receives the information about a detected commodity from the detection terminal 4 each time the detection terminal 4 detects a commodity. The processing circuit 10 starts the comparison between the already registered items and the detected commodity as soon as the commodity registration begins, and executes the comparison process in real time during the commodity registration. The processing circuit 10 causes the main memory 11 or the storage 12 to hold a comparison result for each comparison made. The processing circuit 10 eventually ends the comparison process between the registered items and the detected items upon receiving the registration end instruction or the payment instruction. The processing circuit 10 acquires final comparison information based on the real-time comparisons.

As described above, the POS terminal 1 can acquire comparison information based on the registration end instruction or the payment instruction. The POS terminal 1 can execute processing for outputting a notification based on the comparison information thus received.

When an unregistered commodity is present at the time of input of the registration end instruction or the payment instruction, it is highly likely to be taken away from the store without payment. The POS terminal 1 can appropriately determine whether there is an unregistered commodity by acquiring the comparison information based on the registration end instruction or the payment instruction. Accordingly, the POS terminal 1 can reduce inappropriate commodity registrations being performed by the customers. Further, since the POS terminal 1 may use the detected commodity information (detected based on just a captured image of the item during the checkout process), a more complicated system, such as one requiring the detecting of particular actions (movements) of the customer during the checkout process, is not required. Further, the POS terminal 1 executes the processing for outputting a notification only after the registration end instruction or the payment instruction is input. Therefore, the customer does not receive a notification many times during one transaction, and thus the convenience for the customer is not impaired.

### (Modifications)

The comparison unit 105 and the notification processing unit 106 implemented by the processing circuit 10 of the POS terminal 1 may be implemented by the processing circuit 40 of the detection terminal 4.

A comparison unit implemented by the processing circuit 40 acquires comparison information based on an instruction input by a customer in a manner similar to the comparison unit 105. For example, the processing circuit 40 receives the commodity registration end information from the POS terminal 1. The processing circuit 40 acquires the comparison information after receiving the commodity registration end information. The commodity registration end information is transmitted from the POS terminal 1 to the detection terminal 4 after a registration end instruction or a payment instruction is input by the customer using the input device 15.

The processing circuit 40 may start the comparison between registered items and detected items based on the commodity registration end information being received and then acquire the comparison information. In this example, the processing circuit 40 receives comparison registration information from the POS terminal 1 via the network NW. The processing circuit 40 may receive the comparison registration information from the POS terminal 1 along with the commodity registration end information from the POS terminal 1.

In other examples, processing circuit 40 may start the comparison process before receiving the commodity registration end information and acquire finalized comparison information after receiving the commodity registration end information. In such an example, each time a commodity is registered by the POS terminal 1, the processing circuit 40 receives information about the just registered commodity from the POS terminal 1. The processing circuit 40 can thus start the comparison process between the just registered commodity and the already detected commodities (if any) after the commodity registration is started. The comparison process can be performed in real time during the commodity registration process. The processing circuit 40 causes the main memory 41 or the storage 42 to hold a comparison result for each comparison. The processing circuit 40 ends the comparison between the registered commodity and the detected commodity upon receiving the commodity registration end information. The processing circuit 40 acquires the finalized comparison information based on the real-time comparisons.

The notification processing unit implemented by the processing circuit 40 executes processing similarly to the notification processing unit 106 for outputting a notification based on the comparison information. The processing circuit 40 can execute processing for displaying the notification on the display device 16 of the POS terminal 1. In this example, the processing circuit 40 transmits notification information for displaying the notification on the display device 16 of the POS terminal 1 to the POS terminal 1. The processing circuit 10 of the POS terminal 1 displays the notification on the display device 16 based on the notification information. The processing circuit 40 can execute processing for displaying the notification on the display device of the display terminal 3. In this example, the processing circuit 40 transmits notification information for displaying the notification on the display device of the display terminal 3 to the display terminal 3. The display terminal 3 displays the notification on the display device based on the notification information. The processing circuit 40 can execute processing for displaying the notification on the display device 55 of the attendant terminal 5. In this example, the processing circuit 40 transmits notification information for displaying the notification on the display device 55 to the attendant terminal 5 via the network NW. The processing circuit 50 of the attendant terminal 5 causes the display device 55 to display the notification based on the received notification information.

In some examples, the comparison unit 105 and the notification processing unit 106 implemented by the processing circuit 10 of the POS terminal 1 may be implemented by the processing circuit 50 of the attendant terminal 5.

The comparison unit implemented by the processing circuit 50 acquires comparison information based on an instruction input by a customer in a manner similar to the comparison unit 105. For example, the processing circuit 50 receives the commodity registration end information from the POS terminal 1, then acquires the comparison information after the commodity registration end information or a payment instruction is received.

The processing circuit 50 may start the comparison process upon receiving the commodity registration end information. In such an example, the processing circuit 50 receives comparison registration information from the POS terminal 1 via the network NW. The processing circuit 50 may receive information about a registered commodity from the POS terminal 1 each time the commodity is registered by the POS terminal 1. The processing circuit 50 may receive the comparison registration information from the POS terminal 1 upon receiving the commodity registration end information from the POS terminal 1. The processing circuit 50 receives the comparison detection information from the detection terminal 4 via the network NW. The processing circuit 50 may receive the information about a detected commodity from the detection terminal 4 each time the detection terminal 4 detects a commodity. The processing circuit 50 may receive, from the detection terminal 4, the comparison detection information transmitted by the detection terminal 4 after the commodity registration end information is input.

In some examples, processing circuit 50 may start the comparison between the registered commodities and the detected commodities before receiving the commodity registration end information and acquire the comparison information based on the commodity registration end information. In this example, each time a commodity is registered by the POS terminal 1, the processing circuit 50 receives information about the registered commodity from the POS terminal 1. The processing circuit 50 may receive the information about a detected commodity from the detection terminal 4 each time the commodity is detected by the detection terminal 4. The processing circuit 50 starts the comparison between the registered commodity and the detected commodity after the commodity registration is started, and executes the comparison between the registered commodity and the detected commodity in real time during the commodity registration. The processing circuit 50 causes the main memory 51 or the storage 52 to hold a comparison result for each comparison. The processing circuit 50 ends the comparison between the registered commodity and the detected commodity based on the commodity registration end information. The processing circuit 50 acquires the comparison information based on the comparison.

The notification processing unit implemented by the processing circuit 50 executes processing for outputting a notification based on the comparison information in a manner similar to the notification processing unit 106. The processing circuit 50 can execute processing for displaying the notification on the display device 16 of the POS terminal 1. In this example, the processing circuit 50 transmits notification information for displaying the notification on the display device 16 of the POS terminal 1 to the POS terminal 1. The processing circuit 10 of the POS terminal 1 displays the notification on the display device 16 based on the notification information. The processing circuit 50 can execute processing for displaying the notification on the display device of the display terminal 3. In this example, the processing 50 transmits notification information for displaying the notification on the display device of the display terminal 3 to the display terminal 3. The display terminal 3 displays the notification on the display device based on the notification information. The processing circuit 50 can execute processing for displaying the notification on the display device 55 of the attendant terminal 5. In this example, the processing circuit 50 causes the display device 55 to display the notification.

### OTHER EMBODIMENTS

Although an example in which the detection terminal 4 detects a specific commodity from a captured image has been described, the disclosure is not limited thereto. The detection terminal 4 may detect all the commodities included in a captured image without being limited to specific commodities.

Although the POS terminal 1, with which a customer can perform an operation of commodity registration and an operation of making a payment, has been described as an example of the transaction processing apparatus, the disclosure is not limited thereto. The transaction processing apparatus may be a device with which the customer can perform an operation of commodity registration, and may be separate from a device with which the customer can perform an operation of making a payment. In such a case, the device with which the customer can perform the operation of commodity registration may be a portable device of a self-checkout system. The portable device may be a dedicated terminal mounted on a shopping cart, a mobile terminal prepared in advance by the store, or a mobile terminal owned by the customer.

Each unit described as being implemented by the processing circuit 10 in the above embodiment may instead be implemented by a server capable of communicating with the POS terminal 1. In this case, the server is an example of the transaction processing apparatus.

Separate devices in the information processing system S described in the above embodiment may be integrally implemented in some examples.

Each described unit or function thereof described as being implemented by the processing circuit 10 in the above embodiment is not limited to being implemented by a single device. Such units and/or functions may be implemented by a distributed information processing system distributed across a plurality of devices.

An embodiment may be applied to a device. An embodiment may be applied to a method executed by one or more devices. An embodiment may be a software program or the like capable of causing a computer to execute the described functions as appropriate. An embodiment may be a recording medium that stores a program capable of causing a computer to execute the described functions as appropriate.

When a processing circuit is implemented by a single circuit, the single circuit executes all of the types of processing. When a processing circuit is implemented by a plurality of circuits, each of the circuits may execute a part of the processing. When the processing circuit is a plurality of circuits of different types, the processing of different types may be performed by the appropriate circuit type. When the processing circuit is implemented as a plurality of circuits, the circuits may be provided within one device, or may be distributed among a plurality of devices.

A program of an embodiment may be transferred already stored in a device according to an embodiment or may be transferred separately from the device. In the latter case, the program may be transferred via a network or by being recorded in a recording medium. The recording medium in this context is a non-transitory tangible medium that is a computer-readable medium. A form or format of the recording medium is not limited as long as the recording medium can store the program and can be read by a computer, such as a CD-ROM or a memory card.

While certain embodiments have been described, these embodiments have been presented by way of example only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A retail transaction processing system, comprising:
a point-of-sale terminal; and
a detection apparatus communicatively connected to the point-of-sale terminal and configured to:
receive images from a camera positioned to image operations at the point-of-sale terminal;
receive a transaction start indication from the point-of-sale terminal when a user begins a transaction checkout operation at the point-of-sale terminal;
upon receiving the transaction start indication, begin detecting items in the received images from the camera;
create a detected item list for items detected in the received images;
receive a checkout operation end indication from the point-of-sale terminal;
upon receiving the checkout operation end indication, stop detecting items in the received images from the camera;
receive a registered item list for items registered at the point-of-sale terminal in the transaction checkout operation at the point-of-sale terminal;
compare the detected item list to the registered item list; and
output a notification when an item on the detected item list has no corresponding item on the registered item list.

2. The retail transaction processing system according to claim 1, further comprising:
the camera, wherein
the camera is connected to the detection apparatus via a network connection.

3. The retail transaction processing system according to claim 1, further comprising:
a display terminal proximate to the point-of-sale terminal, wherein
the notification is output to the display terminal.

4. The retail transaction processing system according to claim 3, further comprising:
an attendant terminal communicatively connected to the detection apparatus, wherein
the notification is also output to the attendant terminal.

5. The retail transaction processing system according to claim 1, further comprising:
an attendant terminal communicatively connected to the detection apparatus, wherein
the notification is output to the attendant terminal.

6. The retail transaction processing system according to claim 1, wherein
the point-of-sale terminal is configured to register items in the transaction checkout operation based on information in a commodity master database, and
the detection apparatus is configured to detect only a subset of items listed in the commodity master database.

7. The retail transaction processing system according to claim 1, wherein
the detection apparatus is configured to detect items by category, and
the comparison between the detected item list and the registered item list is done on a category basis.

8. A retail transaction processing system, comprising:
a plurality of point-of-sale terminals;
a camera positioned to image operations at a point-of-sale terminal in the plurality of point-of-sale terminals;
a detection apparatus communicatively connected to the point-of-sale terminal and the camera, the detection apparatus configured to:
receive images from the camera;
receive a transaction start indication from the point-of-sale terminal when a user begins a transaction checkout operation at the point-of-sale terminal;
upon receiving the transaction start indication, begin detecting items in the received images from the camera;
create a detected item list for items detected in the received images;
receive a checkout operation end indication from the point-of-sale terminal;
upon receiving the checkout operation end indication, stop detecting items in the received images from the camera;
receive a registered item list for items registered at the point-of-sale terminal in the transaction checkout operation at the point-of-sale terminal;
compare the detected item list to the registered item list; and
output a notification when an item on the detected item list has no corresponding item on the registered item list.

9. The retail transaction processing system according to claim 8, wherein the camera is connected to the detection apparatus via a network connection.

10. The retail transaction processing system according to claim 8, further comprising:
a display terminal proximate to the point-of-sale terminal, wherein
the notification is output to the display terminal.

11. The retail transaction processing system according to claim 10, further comprising:
an attendant terminal communicatively connected to the detection apparatus, wherein
the notification is also output to the attendant terminal.

12. The retail transaction processing system according to claim 8, further comprising:
an attendant terminal communicatively connected to the detection apparatus, wherein
the notification is output to the attendant terminal.

13. The retail transaction processing system according to claim 8, wherein
the point-of-sale terminal is configured to register items in the transaction checkout operation based on information in a commodity master database, and
the detection apparatus is configured to detect only a subset of items listed in the commodity master database.

14. The retail transaction processing system according to claim 8, wherein
the detection apparatus is configured to detect items by category, and
the comparison between the detected item list and the registered item list is done on a category basis.

15. A detection apparatus for a retail transaction processing system, the detection apparatus comprising:
a communication interface connected to the point-of-sale terminal and a camera positioned to image operations at the point-of-sale terminal; and
a processor configured to:
receive images from the camera via the communication interface;
receive a transaction start indication from the point-of-sale terminal via the communication interface when a user begins a transaction checkout operation at the point-of-sale terminal;
upon receiving the transaction start indication, begin detecting items in the received images from the camera;
create a detected item list for items detected in the received images;
receive a checkout operation end indication from the point-of-sale terminal via the communication interface;
upon receiving the checkout operation end indication, stop detecting items in the received images from the camera;
receive a registered item list for items registered at the point-of-sale terminal in the transaction checkout operation at the point-of-sale terminal;
compare the detected item list to the registered item list; and
output a notification via the communication interface when an item on the detected item list has no corresponding item on the registered item list.

16. The detection apparatus according to claim 15, wherein the notification a display terminal via the communication interface.

17. The detection apparatus according to claim 16, wherein the notification is also output to an attendant terminal via the communication interface.

18. The detection apparatus according to claim 15, wherein the notification is output to an attendant terminal.

19. The detection apparatus according to claim 15, wherein
the point-of-sale terminal is configured to register items in the transaction checkout operation based on information in a commodity master database, and
the detection apparatus is configured to detect only a subset of items listed in the commodity master database.

20. The detection apparatus according to claim 15, wherein
the processor is configured to detect items by category, and
the comparison between the detected item list and the registered item list is done on a category basis.
